(19) United States
(12) Patent Application Publication
(10) Pub. No.: US 2015/0352879 A1
(43) Pub. Date: Dec. 10, 2015

(54) ELECTRONIC APPLARATUS AND METHOD FOR ASSISTING INSTRUMENT PLAYING

(71) Applicants: Hsiu-Ju Lin, (US); Chih-Ta Star Sung, (US); Yuh Susan Hsiao, (US)

(72) Inventors: Chih-Ta Star Sung, HsinChu (TW); Yuh Susan Hsiao, HsinChu (TW); Hsiu-Ju Lin, HsinChu (TW)

(21) Appl. No.: 14/301,327

(22) Filed: Jun. 10, 2014

(51) Int. Cl. B42D 9/04

(52) U.S. Cl. CPC B42D 9/04

(57) ABSTRACT

There is a method using an electrical device assisting users playing at least one instrument. It is able to display the music scores, which acquire a file comprising all kind of music score messages. The method is also able to detect the users' movements and shows the corresponding actions. In addition, there is also an electrical device that combines this method

### BACKGROUND

The idea of present invention is from a father who sees his daughter playing piano and always having the problems of flipping the pages when she plays the piano. Except the simple idea of easy-flipping pages, the father also wants this invention to be fancy and useful. So, users don't have to worry about how to flip the pages except affecting the users. Besides, the invention also has some special functions to let users play the instruments more easily. With this present invention, people may have better lives than ever.

### SUMMARY OF THE INVENTION

According to an embodiment of this invention, a method is provided so that a receiver acquires a file including music score messages which assist users to play the instruments.

In addition, a monitor displays a music tableau based on the music score messages. When encountering repeat signs, the device displays associated whole section of the music score. To zoom in and zoom out the messages, users control the size of the messages by touching or using an adjustor.

In addition, a detector detects movements of the users while referencing the music tableau. The movements to be detected may include sound messages, whether users play the part of the file or not. The movements to be detected may include users' eyeball motion.

In addition, a processor deals with the detections and conducts actions corresponding to the detected movements. The processor records the sound messages of the users and analyses the visual images of eyeballs. For example, the actions include marking the difference from the original music and detected music, playing other part of the files, changing to the next page, changing the colors of the present bar and scrolling.

### BRIEF DESCRIPTION OF THE DRAWINGS

FIG. 1 depicts a block diagram of an embodiment of the present invention including the device 13 and the method 1A.

FIG. 1A depicts four steps of the method 1A conducting in the devices.

FIG. 1B is an example of a music score.

FIG. 1C depicts the principle of the midi file.

FIG. 2 depicts the monitor 21 displaying the music score 22 with repeat sign 23 and repeat section 24.

FIG. 3 depicts the different touching-movements 34-35 showing the different changes 32-33 on the monitor 31.

FIG. 4 depicts the detector 42 detecting the sound messages 41 and marking the differences 45 on the monitor 44.

FIG. 5 depicts the device 13 playing other part of the music.

FIG. 6 depicts the detector 62 detecting the eyeball movements 61 and showing the changes on the monitor 64.

FIG. 7 depicts the detector 72 detecting the sound messages 71 and showing the changes on the monitor 74.

### DETAILED DESCRIPTION

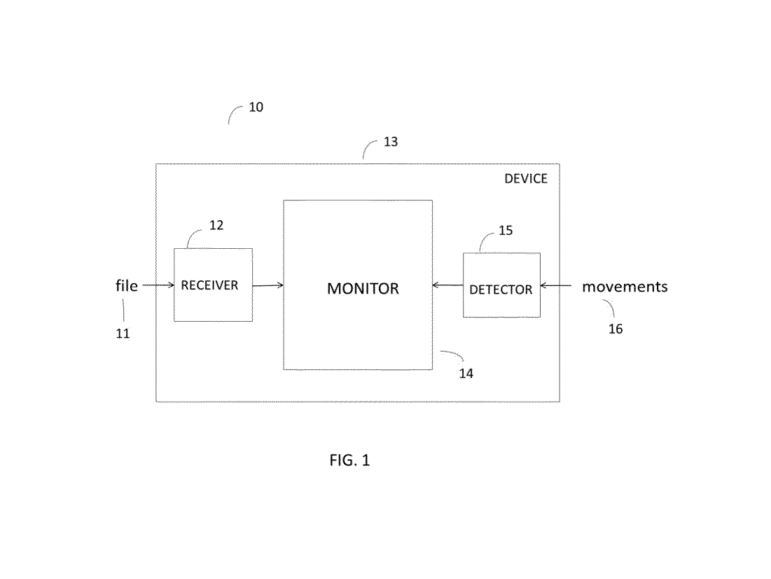

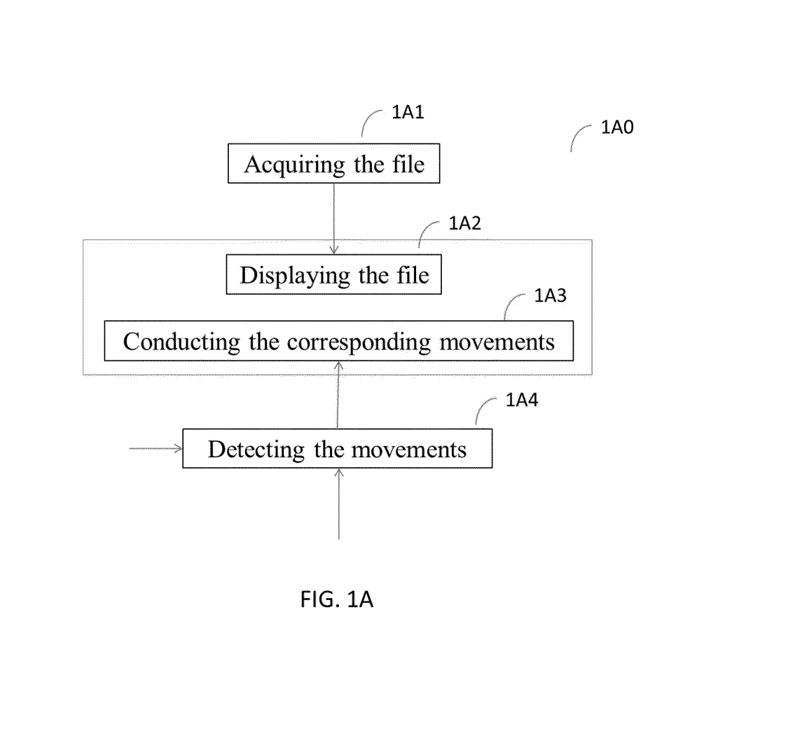

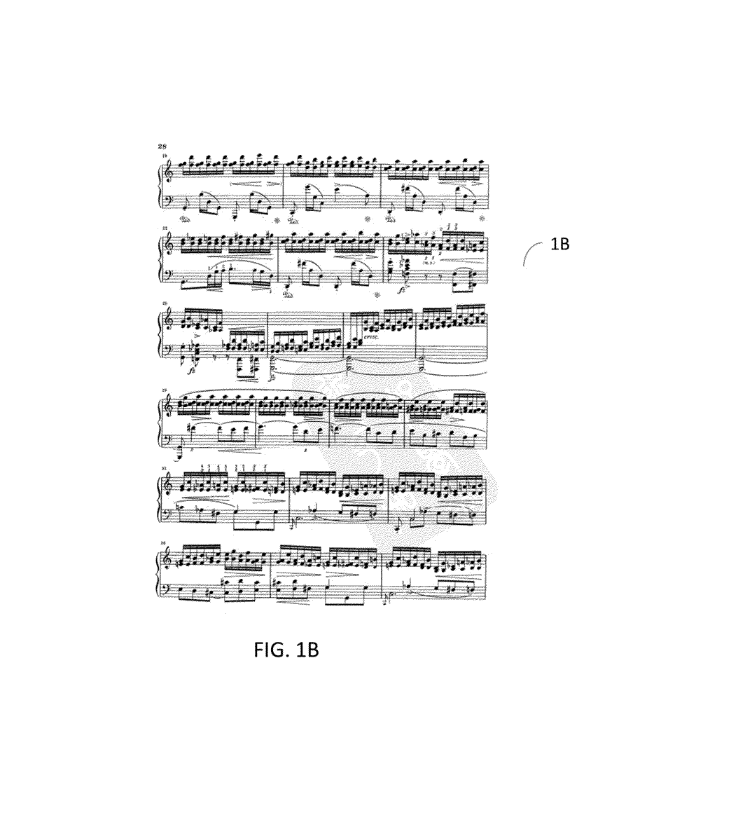

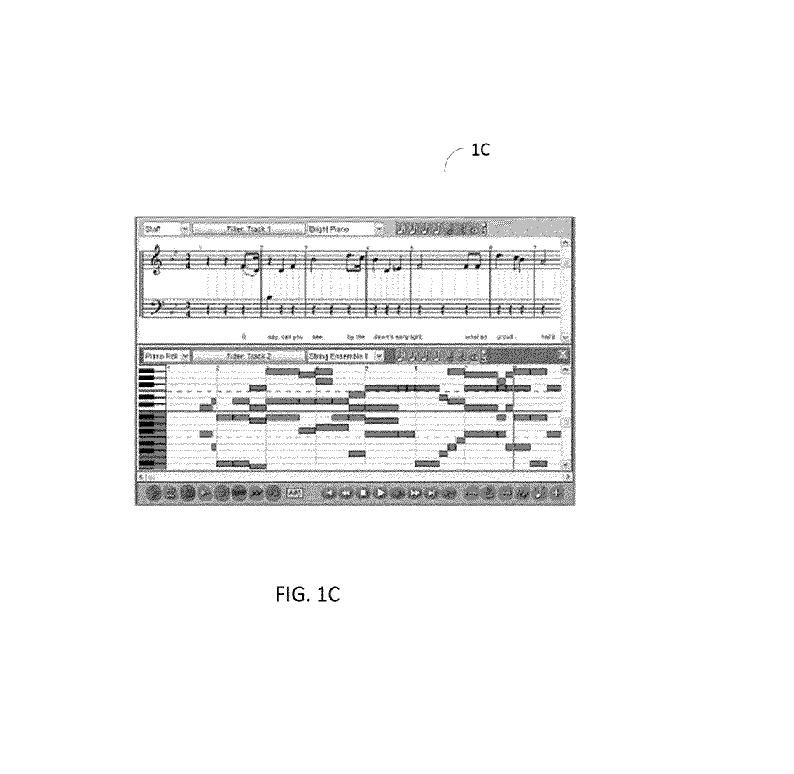

FIG. 1 shows, generally at 10, a simplified block diagram of a device 13. The device has four steps to present its function: first, acquiring the file 11, second, displaying the file contents through the monitor 14, then detecting some assigned movements 16 like sound and action by the detector 15 and the last step, conducting the corresponding responses on the monitor 14. The monitor 14 is capable of showing both black-white tableau or colorful tableau.

The receiver 12 acquires the file 11 through different approaches comprised of Internet, out-source medias, cameras, external devices or internal memory. The file 11 may be any kind like image file or music file. For example, image files like jpg, gif, jpeg, referred to as FIG. 1B and the music file includes MIDI file, the digital information of the music referred to as FIG. 1C.

Speaking of the image files, FIG. 1B shows different form of the music score. The format of the gif can be explained as blow: supporting up to 8 bits per pixel for each image, allowing a single image to reference its own palette of up to 256 different colors chosen from the 24-bit RGB color space. It also supports animations and allows a separate palette of up to 256 colors for each frame. Prove likewise, the other kinds of image file are similar with the gif file.

JPEG compression is used in a number of image file formats. In computing, JPEG (seen most often with the .jpg extension) is a commonly used method of loss compression for digital photography (i.e. images). The degree of compression can be adjusted, allowing a selectable tradeoff between storage size and image quality. JPEG typically achieves 10:1 compression with little perceptible loss in image quality, and is the file type most often produced in digital photography or computer screenshots.

On the other hand, FIG. 1C shows another form of the music score, MIDI file. MIDI is a technical standard that describes a protocol, digital interface and connectors and allows a wide variety of electronic musical instruments, computers and other related devices to connect and communicate with one another. A single MIDI link can carry up to sixteen channels of information, each of which can be routed to a separate device.

After receiving the file 11 including music score messages, display the messages through the monitor 14 with different forms. For example, redivide the messages into different plural units or display the messages by successive file message.

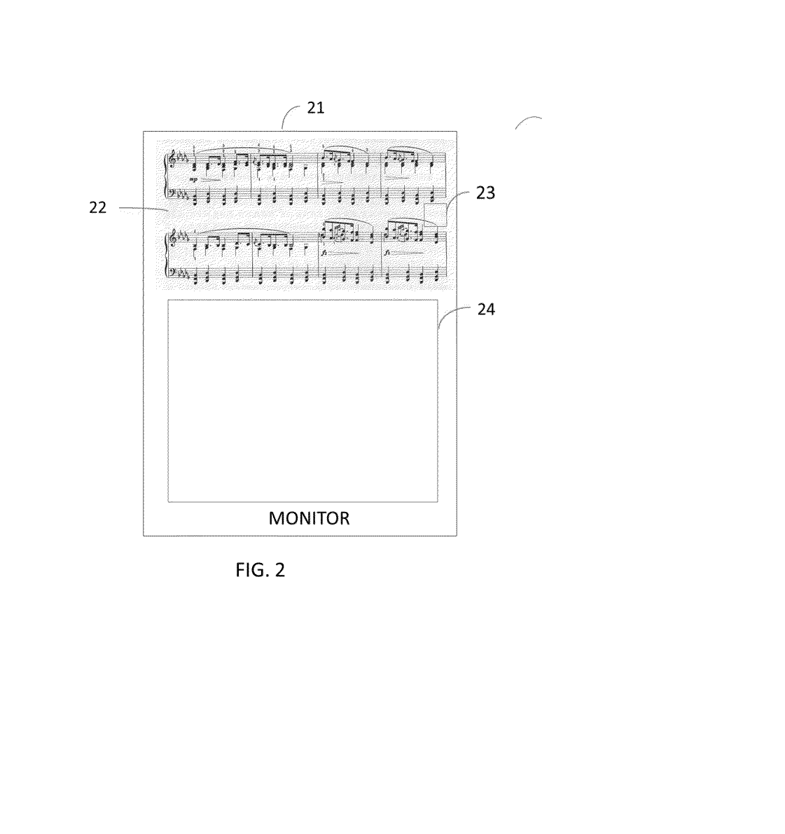

There are many different forms and different kind of ways to display. The messages may be redivided into several parts in order to let users use properly. When facing the repeat signs 23, which may be explained in FIG. 2, the method may adjust the music score to suitable size and proper sections. Or the method may display the music score successively. In this case, users don't have to flip the pages and can easily see the whole messages.

The ways to display the file contents include electronic paper with e-ink, TFT LCD monitor, television screen, projector or etc. Electronic paper, e-paper and electronic ink are display technologies which are designed to mimic the appearance of ordinary ink on paper. Unlike conventional backlit flat panel displays which emit light, electronic paper displays reflect light like ordinary paper, theoretically making it more comfortable to read, and giving the surface a wider viewing angle compared to conventional displays. An ideal e-paper display can be read in direct sunlight without the image appearing to fade.

A thin-film-transistor liquid-crystal display (TFT LCD) is a variant of a liquid-crystal display (LCD) that uses thin-film transistor (TFT) technology to improve image qualities such as addressability and contrast. A TFT LCD is an active-matrix LCD, in contrast to passive-matrix LCDs or simple, direct-driven LCDs with a few segments.

Apple products now have retina display. Retina Display is a brand name used by Apple for liquid crystal displays which they claim have a high enough pixel density that the human eye is unable to notice pixilation at a typical viewing distance. The term is used for several Apple products, including the iPhone, iPod Touch, iPad, and MacBook Pro. As the typical viewing distance would be different depending on each device's usage, the pixels per inch claimed to be of retina quality can be different depending on the size of the display. When an Apple product has retina display, each user interface widget is doubled in width and height to compensate for the smaller pixels.

The detector 15 detects all the movements 16 of the users. The movements may include eyeball movements and sound messages played by users. The corresponding reactions will conduct on the monitor 14 after the detector 15 analyzes them.

Eye movement (ocular motility) is the voluntary or involuntary movement of the eyes, helping in acquiring, fixating and tracking visual stimuli. It may also compensate for a body movement, such as when moving the head. Eyes are the visual organs that have the retina, a specialized type of brain tissue containing photoreceptors. These specialized cells convert light into electrochemical signals through the ganglion cell layer and travel along the optic nerve fibers to the brain.

Referred to as FIG. 1, the four major steps of the device is corresponding to the main idea of the method. FIG. 1A shows the four steps of the method conducting the whole idea.

First, the method acquires the file in different ways 1A1. The ways to acquire the file include getting from the Internet, out-source medias, cameras, external devices or internal memory.

Second, the method displays the acquired files 1A2. The method displays the file through electronic paper (e-paper with e-ink), LCD monitor, television screen, projector and etc.

Then, the method detects the users' any kind of movements 1A3. the movements include users' eyeball movements, music sound and any kind of movement that may be recognized as any changes.

In the end, the method may conduct the corresponding movements according to the detected actions 1A4. The corresponding movements are comprised of flipping pages, changing colors of the present bar or marking the wrong music notes.

FIG. 2 shows, generally at 20, the reactions when the device encounters the repeat signs 23. When the music messages 22 include any kind of repeat signs 23, the monitor 21 then display the repeat sections 24 automatically to reduce the movements of flipping pages.

In music, a repeat sign is a sign that indicates a section should be repeated. If the piece has one repeat sign alone, then that means to repeat from the beginning, and then continue on (or stop, if the sign appears at the end of the piece). A corresponding sign facing the other way indicates where the repeat is to begin. These are similar to the instructions da capo (D.C.) and dal segno (D.S.).

When a repeat calls for a different ending, number brackets above the bars indicate which to play the first time, which to play the second time, etc. These are called “first-time bars” and “second-time bars,” or “first and second endings.” They are also known as “volta brackets” and have no limit to how many there can be.

There are many ways to flip the pages. The music score, according to the acquired files, may be separated into different sections. When encountering the repeat signs, the device automatically separates the music score messages into the sections needed to be repeated. The ways to display the repeat sections include showing the whole block of the repeat section or showing the repeat section successively. After the repeat sections, the method may display the original music score messages as usual. So users don't have to worry about finding the original music score after the repeat parts.

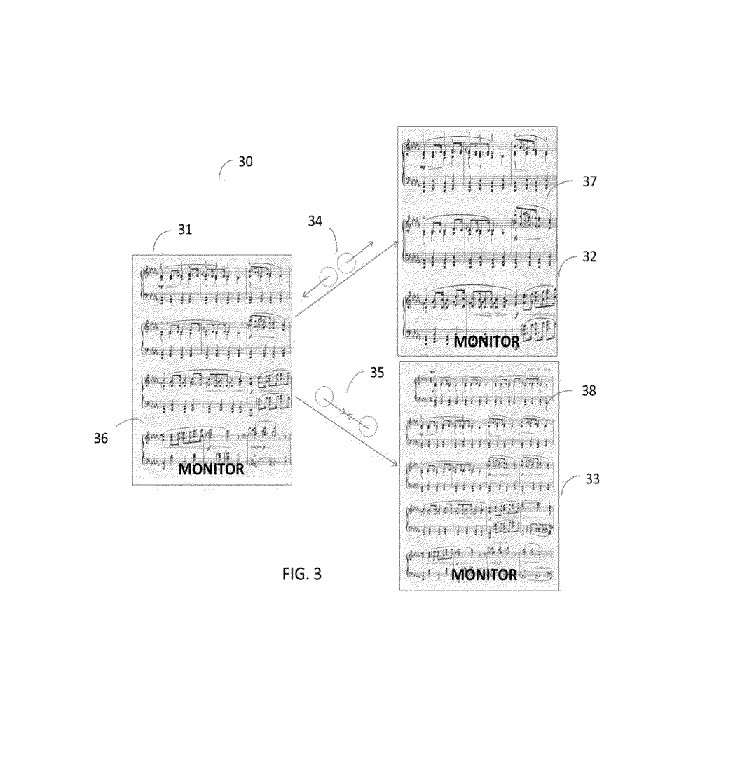

FIG. 3 shows, generally at 30, the reactions when toughing the monitor 31 by different ways 34-35 with users' fingers. At the beginning, the method decides the size-ratio of the music score 36 according to the size of the monitor 31.

At the beginning, the monitor 31 displays the acquired original music score message 36. If the users want to change the size of the music score, they can use their fingers to change the size of them to the suitable size.

There are two touching movements 34-35. First, if the users want to magnify the music scores 36, they can use two of their fingers to control the size of music score 36 by toughing the monitor 32. The movement of the fingers 34 is that choosing any two fingers and sliding them to different directions on the monitor 32. In this way, the music score 37 may be magnified to any sizes users like.

Prove likewise, to narrow the music score 36, choose any two fingers and slide the fingers to each other on the monitor 33. The size of the music score may be controlled by users' fingers. In this way, the music score 38 will be narrowed to any sizes users like.

There are another choice for users. If users don't like the default touching movements, they can set their own touching movements with more than two fingers or even only one finger.

A touchscreen is an electronic visual display that the user can control through simple or multi-touch gestures by touching the screen with one or more fingers. Some touchscreens can also detect objects such as a stylus or ordinary or specially coated gloves. The user can use the touchscreen to react to what is displayed and to control how it is displayed (for example by zooming the text size). The touchscreen enables the user to interact directly with what is displayed, rather than using a mouse, touchpad, or any other intermediate device Touchscreens are common in devices such as game consoles, all-in-one computers, tablet computers, and smartphones.

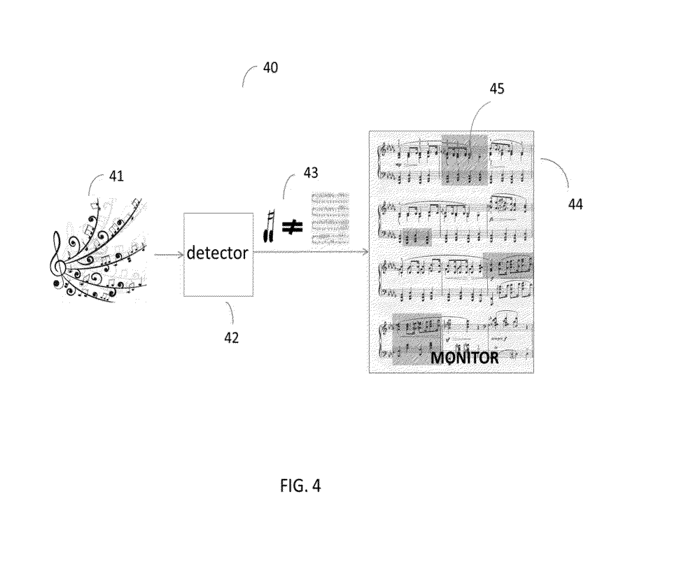

FIG. 4 shows, generally at 40, the reactions 45 after the detector 42 detects the wrong music sound 43. The detector 42 in the device 13 is responsible for detecting different actions or movements like eyeballs and sound. After the detection, the detector 42 will record the music users play, analyze the music sound and compare it with the original music score 36.

The method understands all the music notes so it is capable of comparing the differences. At the beginning, the method may scan all the file contents and records all the messages related to the music score. In this case, when users play the instruments, the method may record all the sound messages and compare them with the notes it scan.

A musical instrument is a device created or adapted to make musical sounds. In principle, any object that produces sound can be a musical instrument—it is through purpose that the object becomes a musical instrument. Musical instrument classification is a discipline in its own right, and many systems of classification have been used over the years. Instruments can be classified by their effective range, their material composition, their size, etc. However, the most common academic method, Hornbostel-Sachs, uses the means by which they produce sound.

The music users play will be carefully compared and in the end, mark 45 all the differences on the monitor 44. The ways of marking 45 the differences include changing the colors of the wrong music notes, placing the signs above the wrong music notes or any methods that can specialize the differences.

To compare means to examine or look for the difference between two or more things. The method may compare every single notes with the sound messages. After comparing the whole music or the partial section users play, the method may light the difference with many ways.

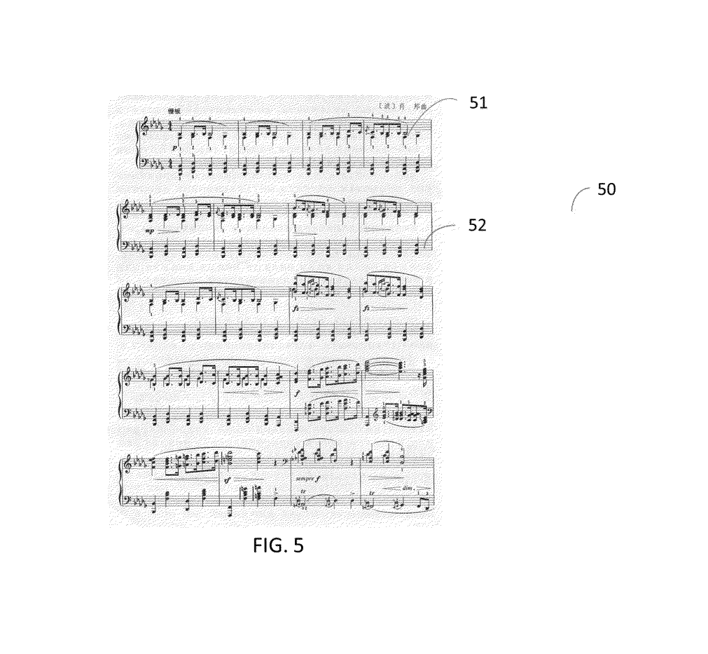

FIG. 5 shows the special method of the device 13. The method may detect the sound messages users play and identify whether the users play the whole music score or only the part of it. If the users only play part of the music score 51, the method play to other instrument accompaniment 52. At the same time, the smart metronome may adjust the users to the right speed according to the playing speed.

If the users want to practice only one hand or one instrument, it can be chosen to only display the music score and do no accompaniment. In addition, users can also choose whether to turn on the smart metronome or not. The smart metronome is not like the normal metronome. It is capable of following the users playing speed and adjust the playing speed to the right speed of the songs. Sometimes users may also choose their suitable playing speed to practice.

A metronome is any device that produces regular, metrical ticks (beats, clicks) settable in beats per minute. These ticks represent a fixed, regular aural pulse; some metronomes also include synchronized visual motion (e.g. pendulum-swing). The metronome dates from the early 19th century, where it was patented by Johann Maelzel in 1815 as a tool for musicians. The metronome is used by musicians to help keep a steady tempo as they play, or to work on issues of irregular timing, or to help internalize a clear sense of timing and tempo. The metronome is also often used by composers as a standard tempo reference, to indicate the intended tempo for the piece.

Other smart function of this method is that the method is capable of harmonizing with the sound volume. No matter how loud the players play, the method may harmony with its volume. When the music score shows the “piano” sign, if users play too loud, the method may tell the users to play lightly; on the other hand, if the music score shows the “forte” sign and users play too tranquil, the method may tell the users to play loudly.

To make this function more specific. Let's take piano for example, users normally use two hands to play the piano. When users play only right hand, the method first detects the sound messages, identify them then play the left hand piano accompaniment. Prove likewise, if users play only left hand, the method first detects the sound messages, identify them then play the right hand piano accompaniment.

Another example is an instrumental ensemble. There may be two or more instruments play at the same time. in this case, the method first detects which part of the music score does the users play. After confirming which part users play, the method starts to play other instruments accompaniment. If there are more than two score of different instruments, users can choose which instrument accompaniments do they want.

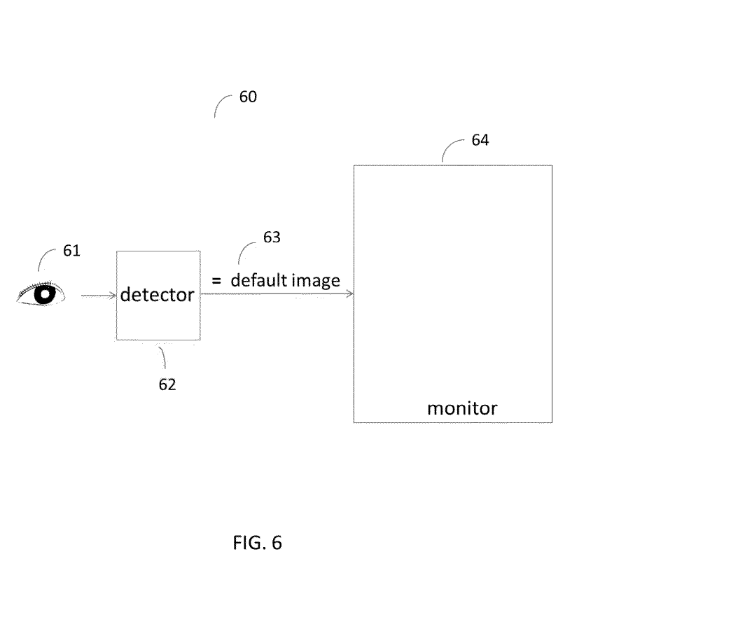

FIG. 6 shows, generally at 60, the detector 62 detecting the users' eyeball movements 61 and comparing it with the default images 63 note by note then displaying the changes on the monitor 64.

The detection 61 is eyeball visual images. Visual image detection technology (VID) is input the image-analysis instrument for image analysis, especially widely used in video surveillance systems. Through setting the image analysis system, you can target an intruder moving objects, flames, smoke and other special event and trigger settings. It can achieve the effect of early warning.

When the detector 62 detects the eyeball movements, the method may confirm whether the movements are equal to the default images. The eyeball movements include rolling the eyeballs, blinking the eyes or etc. The default eyeball visual images may be set by users themselves to specialize the specific movements for users. After detection, the method starts to compare the detected eyeball images with default images.

To compare means to examine or look for the difference between two or more things. Comparing every single eyeball visual images carefully in order to make sure the exact orders users make. After comparing, the method may display the changes through the monitor 64. The changes are comprised of flipping to the next page, changing the colors of the present bar or scrolling.

There are many ways to flip the pages. Separate the while music score to smaller sections and show one section after another. Or show the whole music score in successive ways. It means that when finish the first line of the music score, the method may automatically show the first line of the next page at the lowest place.

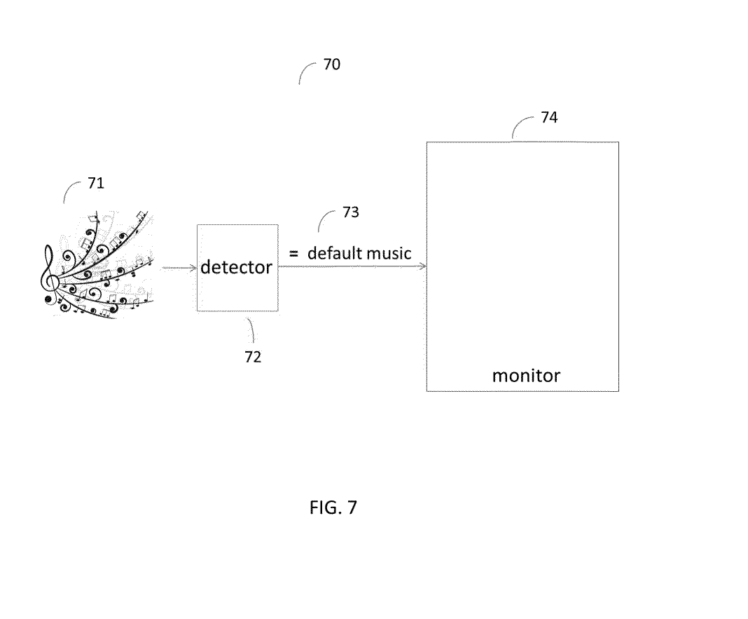

FIG. 7 shows, generally at 70, the detector 72 detecting the sound 71 users play and comparing it with the default music notes 73 then displaying the changes on the monitor 74.

The detector 72 is responsible for detecting the sound messages 71 and the movements of the users and analyzing them. The movements include nodding, shaking the head and etc.

When the detector 72 detects the sound of music, the method may confirm whether the sounds are equal to the default music. The music sound means any kind of instrument sound. The sound may be only part of the whole music score. Take piano for example, if the detector 72 only detects one hand sound, it is still capable of knowing where to flip the pages.

The default sounds may be set when the device gets the music file. After detection, the method starts to compare the detected sound with default notes. To compare means to examine or look for the difference between two or more things. Comparing every music sound carefully in order to make sure the exact movements users want. After comparing, the method may display the changes through the monitor 74. The changes are comprised of flipping to the next page, changing the colors of the present bar or scrolling.

There are many ways to flip the pages. Separate the while music score to smaller sections and show one section after another. Or show the whole music score in successive ways. It means that when finish the first line of the music score, the method may automatically show the first line of the next page at the lowest place.

What is claimed is:

1. A method using an electrical device assisting an user playing at least one instrument comprising:
acquiring a file, which includes music score messages which assists users playing the instrument;
the electrical device displaying the music tableau based on the music score messages;
detecting the movements of the users according to the music tableau, and;
conducting a corresponding action, according to the movements detected.

2. The method of claim 1, wherein the method encounters the repeat signs and displays the whole section automatically.

3. The method of claim 1, wherein the contents of files are capable of being zoomed in and zoomed out through the screen by touching

4. The method of claim 3, wherein the contents of files are capable of being touched through the monitor and when choosing the assigned section by touching, the section would adjust to the size of the screen.

5. The method of claim 1, wherein the method detects the sound messages of users, records the different places and marks them.

6. The method of claim 1, wherein the method detects whether the users play the part of the file and play other part of it.

7. The method of claim 6, wherein the smart metronome adjusts the users to the right speed according to the playing speed.

8. The method of claim 1, wherein the method detects the users' eyeball movements and analyses the visual images of eyeballs and if the visual images conform to the default movements, display the corresponding changes on the monitor.

9. The method of claim 8, wherein the corresponding changes include changing to the next page, changing the colors of the present bar or scrolling.

10. The method of claim 1, wherein the method detects the sound messages of the users' movements and brings the changes according to the detected messages.

11. The method of claim 10, wherein the corresponding changes include changing to the next page, changing the colors of the present bar or scrolling.

12. An electrical device with an input and output interface comprising:
a receiver which acquires a file including music score messages used for users playing the instruments;
a monitor which displays a music score tableau based on the music score messages;
a detector which detects the movements of the users according to the music tableau, and;
a processor conducts a corresponding action according to the movements detected.

13. The electric device of claim 12, wherein the device encounters the repeat signs and displays the whole section automatically.

14. The electric device of claim 12, wherein the contents of files are capable of being zoomed in and zoomed out through the adjuster.

15. The electric device of claim 12, wherein the detector is capable of detecting the sound messages of users, record the different places and mark them.

16. The electric device of claim 12, wherein the detector is capable of detecting whether the users play the part of the file and play other part of it.

17. The electric device of claim 12, wherein the detector is capable of detecting the users' eyeball movements and analyses the visual images of eyeballs and if the visual images conform to the default movements, display the corresponding changes on the monitor.

18. The electric device of claim 17, wherein the corresponding changes include changing to the next page, changing the colors of the present bar or scrolling.

19. The electric device of claim 12, wherein the detector is capable of detecting the sound messages of the users' movements and brings the changes according to the detected messages.

20. The electric device of claim 19, wherein the corresponding changes include changing to the next page, changing the colors of the present bar or scrolling.
